(19) United States
(12) Patent Application Publication
(10) Pub. No.: US 2018/0115779 A1
(43) Pub. Date: Apr. 26, 2018

(54) IMAGE PROCESSING APPARATUS AND METHOD UTILIZING MULTIPLE PROCESSORS

(71) Applicant: MStar Semiconductor, Inc., Hsinchu Hsien (TW)

(72) Inventors: Sung-Wen Wang, Zhubei City (TW); Yi-Shin Tung, Zhubei City (TW)

(21) Appl. No.: 15/425,015

(22) Filed: Feb. 6, 2017

(30) Foreign Application Priority Data
Oct. 25, 2016 (TW) 105134412

(51) Int. Cl. H04N 19/436; H04N 19/91; H04N 19/80

(52) U.S. Cl. CPC H04N 19/436; H04N 19/80; H04N 19/91

(57) ABSTRACT

An image processing apparatus for reconstructing an image frame including multiple image segments is provided. The multiple image segments are converted to a bitstream through entropy encoding. The image processing apparatus includes a shared storage region, a first processor and a second processor. The first processor performs entropy decoding on the bitstream to generate a set of first symbols, reconstructs a first image segment according to the set of first symbols, and stores the reconstructed first image segment into the shared storage region. The second processor also performs entropy decoding on the bitstream to generate a set of second symbols, obtains the part of the reconstructed image segment that is associated with a second image segment, and reconstructs the second image segment according to the set of second symbols and the obtained part of the first image segment.

This application claims the benefit of Taiwan application Serial No. 105134412, filed Oct. 25, 2016, the subject matter of which is incorporated herein by reference.

### BACKGROUND OF THE INVENTION

### Field of the Invention

The invention relates in general to an image processing system, and more particularly to an image decoding technology that utilizes multiple processors in a parallel manner.

### Description of the Related Art

Along with the vigorous progressing of various kinds of electronics related technologies in the recent years, multimedia systems such as home theaters have become increasingly popular. Among the numerous multimedia systems, the most critical hardware devices are categorized as image display apparatuses. To satisfy viewers' demands for realistic images, one current development trend of image display apparatuses is continually increasing the size and resolution of image frames.

For image processes of both dynamic and still images, each image frame is usually divided into multiple image blocks individually serving as a fundamental encoding/decoding unit. At an encoding end of many dynamic image processing systems, each image block undergoes following processes: 1) intra-prediction or motion compensation, 2) discrete cosine transform (DCT), 3) quantization and 4) entropy encoding. The processes (1) to (3) may be collectively referred to as a pixel deconstruction process that outputs a series of symbols; the subsequent entropy decoding converts these symbols into a bitstream.

Generally to one person skilled in the art, a decoding end needs to perform image processes inverse to those at the encoding end in order to correctly reconstruct the image blocks in an image frame. In many dynamic image processing systems, a decoding end handling the reconstruction of image frames is designed to perform following processes on a received bitstream: 1) entropy decoding, 2) inverse quantization, 3) inverse transform, 4) intra pixel reconstruction or motion compensation, and 5) deblocking filtering. To correspond to a transmitting end, the entropy decoding at the receiving end transforms a bitstream into multiple symbols, and the image processes (2) to (5) are collectively referred to as pixel reconstruction that reconstructs each of the pixels in the image blocks according to the symbols.

Different image blocks of the same image frame are often designed to have encoding/decoding dependency. More specifically, to reconstruct an image block (x, y) in FIG. 1 using pixels, such reconstruction can only be conducted when image data of all of the four image blocks (x−1, y−1), (x, y−1), (x+1, y−1) and (x−1, y) is available. For example, to perform inverse quantization on the image block (x, y), the decoder needs to first obtain quantization parameters of the image blocks (x, y−1) and (x−1, y) before the quantization parameter of the image block (x, y) can be accordingly determined.

In a bitstream generated from entropy decoding, the dependency between two successive sets of data is even more intense. More specifically, when an entropy decoder is to encode a symbol, the entropy decoder refers to contents of the previous symbol. Thus, an entropy decoder needs to sequentially decode the symbols one after another from a bitstream. More specifically, the entropy decoder needs to use symbols that have been decoded as parameters in order to decode a next symbol. In many dynamic image processing systems, the entropy encoder encodes image data of one entire image frame into a bitstream. Because the bitstream is a variable length code, the entropy decoder has no way of learning in advance the positions at which data of each image block starts and ends in the bitstream. Taking FIG. 1 for example, the entropy decoder can identify a starting bit of the image block (x, y−1) in the bitstream and start decoding symbols of the image block (x, y−1) only after all of the symbols of the image block (x−1, y−1) have been decoded. Similarly, all symbols of the image block (x, y−1) need to be first decoded for the entropy decoder to find a starting bit of the image block (x+1, y−1) in the bitstream and start decoding to generate the symbols of the image block (x+1, y−1).

Based on the above characteristics of entropy coding, a typical approach is designating the entropy decoding to be entirely handled by one single processor. After the processor completes decoding the symbols of the whole image frame, one or more processors then reconstruct the pixels. FIG. 2 shows exemplary timing diagrams of the above approach realized by two processors. To keep the description simple and concise, it is assumed that an image frame includes only the image blocks (x−1, y) and (x, y), and a first processor between two processors handles the entire entropy decoding. As shown in FIG. 1, the first processor completes the entropy decoding of the image block (x−1, y) between the time points t1 and t2, and performs the entropy decoding on the image block (x, y) between the time points t2 and t3. After completing the entropy decoding of both of the image blocks, the first processor starts to perform pixel reconstruction for the image block (x−1, y). As previously described, the pixel reconstruction performed for the image block (x, y) may need to refer to some pixel data of the image block (x−1, y). Thus, only after the first processor has generated such reference data at a time point t4, the second processor then starts to perform pixel reconstruction for the image block (x, y).

In an image processing system where an image frame size is larger and immediate image frame display is demanded, the time that can be allotted for decoding each image frame is quite limited. Therefore, there is a need for a solution that shortens the decoding time to increase the overall amount of processed data.

### SUMMARY OF THE INVENTION

The invention is directed to an image processing apparatus and an image processing method. By appropriately scheduling multiple processors that start operating in parallel in an entropy decoding phase, the image processing apparatus and image processing method of the present invention are capable of accelerating the speed of reconstructing an entire image frame. In practice, the image processing apparatus and image processing method of the present invention may be realized in various image decoding systems needing to reconstruct image frames through entropy decoding and pixel reconstruction.

An image processing apparatus is provided according an embodiment of the present invention. The image processing apparatus is for reconstructing an image frame, which includes a first image segment and a second image segment. The first image segment and the second image segment are previously converted to a bitstream through pixel deconstruction and entropy encoding. In the bitstream, multiple bits associated with the second image segment are subsequent to multiple bits associated with the first image segment. The image processing apparatus includes a shared storage region, a first processor and a second processor. The first processor performs entropy decoding on the bitstream to generate a set of first symbols, performs pixel reconstruction according to the set of first symbols to reconstruct the first image segment, and stores the reconstructed first image segment into the shared storage region. The second processor also performs the entropy decoding on the bitstream to generate a set of second symbols, obtains a part of the reconstructed first image segment that is associated with the second image segment from the shared storage region, and performs pixel reconstruction according to the set of second symbols and the obtained part of the first image segment to reconstruct the second image segment.

An image processing method is provided according an embodiment of the present invention. The image processing method is for reconstructing an image frame that includes a first image segment and a second image segment by using a first processor, a second processor and a shared storage region. The first image segment and the second image segment are previously converted to a bitstream through pixel deconstruction and entropy encoding. In the bitstream, multiple bits associated with the second image segment are subsequent to multiple bits associated with the first image segment. According to the image processing method, the first method is used to perform entropy decoding on the bitstream to generate a set of first symbols, to perform pixel reconstruction according to the set of first symbols to reconstruct the first image segment, and to store the reconstructed first image segment into the shared storage region. The second processor is used to perform entropy decoding on the bitstream to generate a set of second symbols, to obtain a part of the reconstructed first image segment that is associated with the second image segment from the shared storage region, and to perform pixel reconstruction on the set of second symbols and the obtained part of the first image segment to reconstruct the second image segment.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) shows examples of encoding/decoding dependency among multiple image blocks;

FIG. 2 (prior art) is an exemplary timing diagram of entropy decoding and pixel reconstruction realized by two processors in a conventional solution;

FIG. 3 is a functional block diagram of an image processing apparatus according to an embodiment of the present invention;

FIG. 4 is a schematic diagram of an image frame including multiple image blocks;

FIG. 5(A) to FIG. 5(C) are timing diagrams of scheduling examples that may be adopted by an image processing apparatus according to an embodiment of the present invention; and

FIG. 6 is a flowchart of an image processing method according to an embodiment of the present invention.

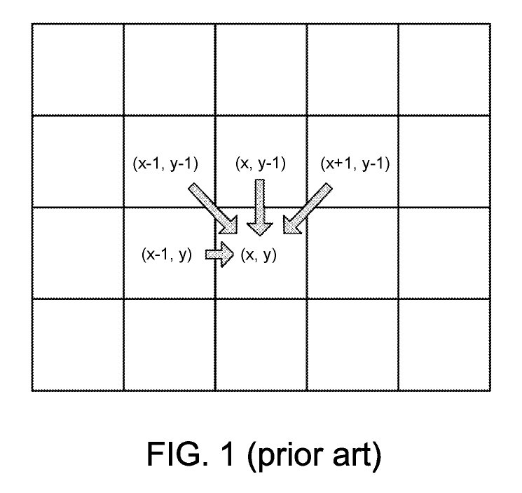

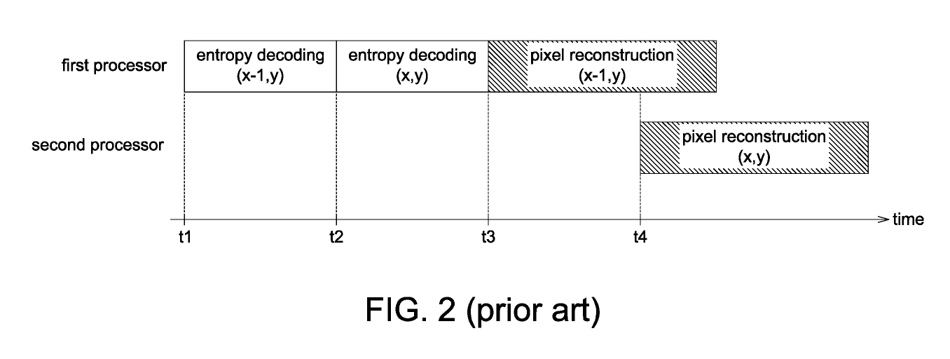

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

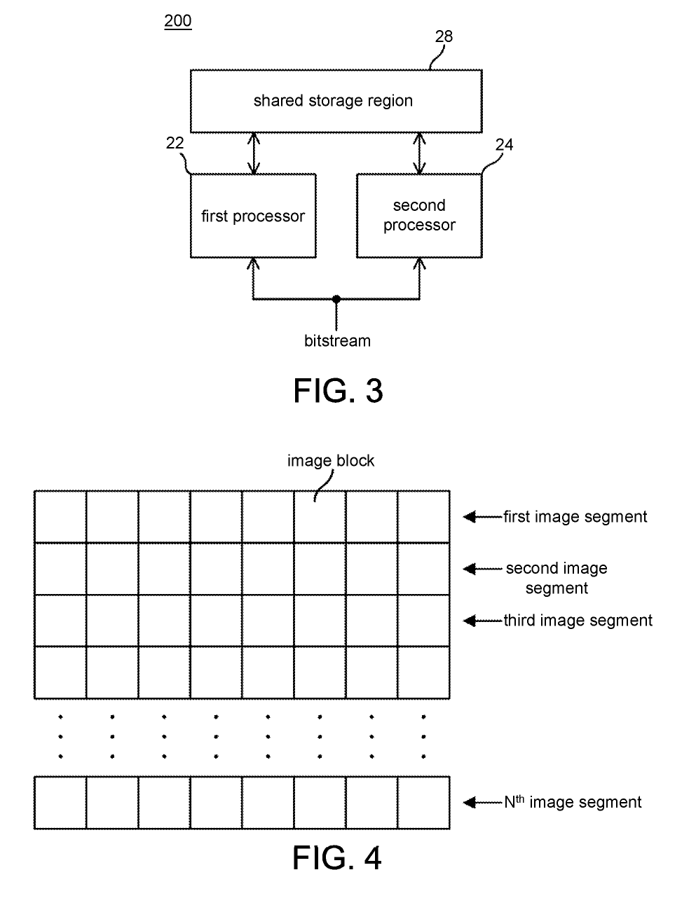

FIG. 3 shows a functional block diagram of an image processing apparatus according to an embodiment of the present invention. It should be noted that, the term “the present invention” refers to inventive concepts of embodiments, and covers a scope that is not limited by these non-limiting embodiments below. In practice, an image processing apparatus 200 may be integrated in various image decoding systems needing to reconstruct image frames through entropy decoding and pixel reconstruction (for example but not limited to, inverse quantization, inverse transform, motion compensation and deblocking filtering processes), for either still images or dynamic images.

As shown in FIG. 3, the image processing apparatus 200 includes a first processor 22, a second processor 24, and a shared storage region 28. In practice, the first processor 22 and the second processor 24 may be two sets of image processing circuits or processors capable of performing associated functions (to be described later), and are independently operable. The first processor 22 and the second processor 24 may be designed to operate according to predetermined schedules. Alternatively, the image processing apparatus 200 may include a controller (not shown), which controls the first processor 22 and the second processor 24 to accordingly perform the allocated tasks. It should be noted that, the function of the controller may be realized through the first processor 22 or the second processor (e.g., by executing corresponding program codes) rather than independent hardware. When an independent controller is not provided, a mechanism may be provided between the first processor 22 and the second processor 24 to exchange information (e.g. issuing an interrupt request), so as to inform the other processor of an operation status.

An input signal transmitted to the image processing apparatus 200 is a bitstream. The bitstream is formed from multiple pixels converted through pixel deconstruction and entropy encoding. In the example below, it is assumed that the image processing apparatus 200 is used to reconstruct an image frame divided into multiple image blocks, as shown in FIG. 4. Further, among these image blocks, the image blocks located at odd horizontal rows (1^{st}, 3^{rd}, 5^{th} . . . rows) are primarily reconstructed by the first processor 22, and the image blocks located at even horizontal rows (2^{nd}, 4^{th}, 6^{th} . . . rows) are primarily reconstructed by the second processor 24. With the description below, one person ordinary skilled in the art can understand that the scope of the present invention is not limited to the above assumption.

To better explain the description below, among the image blocks, multiple image blocks located at the 1^{st} horizontal row are collectively referred to as a first image segment, multiple image blocks located at the 2^{nd} horizontal row below are collectively referred to as a second image segment, multiple image blocks located at the 3^{rd} horizontal row below are collectively referred to as a third image segment, and so forth. Having undergone pixel deconstruction and entropy decoding, the image segments are converted to a bitstream, which is inputted into the first processor 22 and the second processor 24. In the bitstream, multiple bits associated with the second image segment are subsequent to multiple bits associated with the first image segment, multiple bits associated with the third image segment are subsequent to multiple bits associated with the second image segment, and so forth.

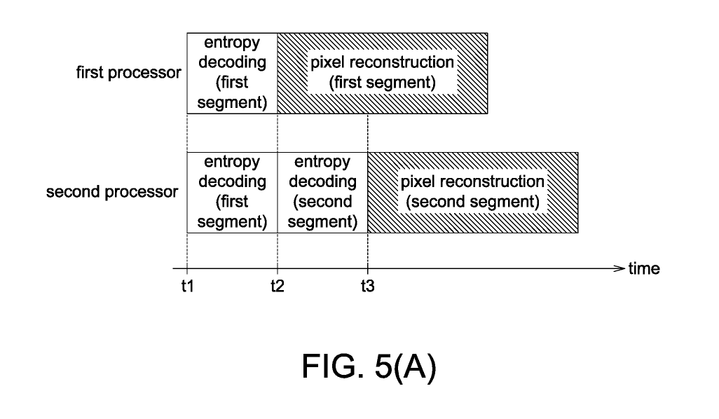

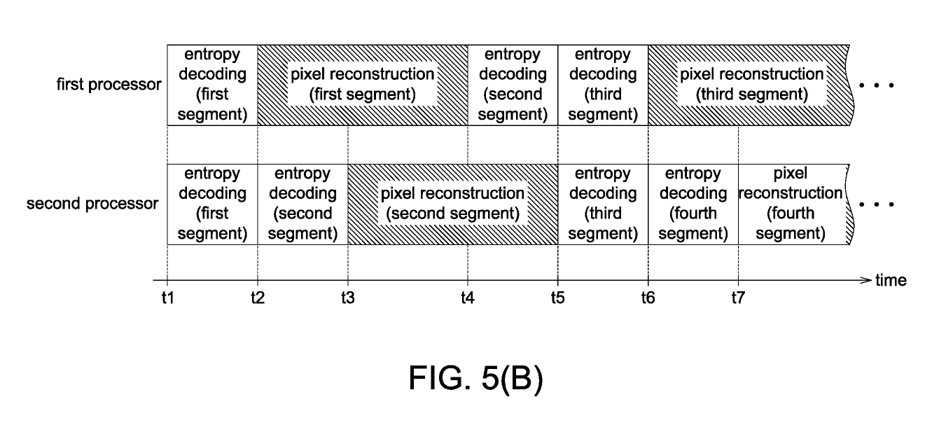

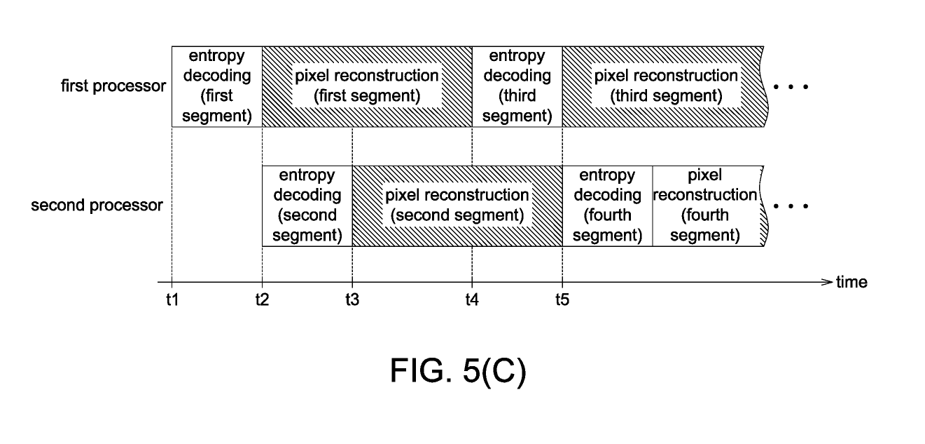

FIG. 5(A) to FIG. 5(C) show timing diagrams of several scheduling examples that may be adopted by the image processing apparatus 200. Associated details are given below.

In the example in FIG. 5(A), the first processor 22 and the second processor 24, starting from a starting bit of the first image segment at the time point t1, independently perform entropy decoding on the bitstream. As shown in FIG. 5(A), the first processor 22 and the second processor 24 operate in parallel. In the above situation, the first processor 22 and the second processor 24 generate respective multiple symbols associated with pixels included in the first image segment. After the entropy decoding performed by the first processor 22 has generated all symbols associated with the pixels included in the first image segment (at a time point t2), the first processor 22 suspends entropy decoding, starts to perform pixel reconstruction on the symbols to reconstruct the first image segment, and stores the reconstructed first image segment into the shared storage region 28. The so-called pixel reconstruction may include at least one of processes of, for example but not limited to, inverse quantization, inverse transform, intra pixel reconstruction or motion compensation, and deblocking filtering.

If the operation speeds of the first processor 22 and the second processor 24 are the same, the second processor 24 also generates all symbols associated with the pixels included in the first image segment at the time point t2 without utilizing those symbols. Based on the characteristics of entropy coding, after all of the symbols associated with the pixels included in the image segment are generated, the second processor 24 obtains a starting bit of the second image segment from the bitstream to start performing the entropy decoding on the second image segment. Thus, the second processor 24 may immediately perform the entropy decoding on the bitstream from the time point t2, i.e., starting to generate symbols associated with pixels included in the second image segment.

After all of the symbols associated with the pixels included in the second image segment have been generated (at a time point t3), the second processor 24 suspends the entropy decoding. If the image blocks in the second image segment are dependent on the image blocks in the first image segment, the second processor 24 may obtain the part in the reconstructed first image segment that is associated with the second image segment from the shared storage region 28. Next, the second processor 24 may start performing the pixel reconstruction according to the symbols it generated and the obtained part of the first image segment to reconstruct the second image segment. Similarly, the second processor 24 may store the reconstructed second image segment into the shared storage region 28 for subsequent reference for the first processor 22 to later reconstructs the third image segment.

As shown in FIG. 5(A), the time point t3 at which the second processor 24 completes the entropy decoding on the second image segment is later than the time point t2 at which the first processor 22 starts reconstructing the first image segment. In practice, with appropriate timing arrangements, the first processor 22 is caused to complete reconstructing the data and storing the data into the shared storage region 28 before the second process 24 requests to retrieve the reference data from the shared storage region 28. Thus, the second processor 24 may start reconstructing the second image segment right after the entropy decoding on the second image segment is completed. Alternatively, the second processor 24 may wait until the first processor 22 has fully prepared the reference data in the shared storage region 28.

In continuation to the example in FIG. 5(A), referring to FIG. 5(B), starting from an ending bit (i.e., a position at which the first processor 22 previously suspended the entropy decoding) of the first image segment, the first processor 22 may continue performing the entropy decoding on the bitstream after the pixel reconstruction on the first image segment is completed (at a time point t4). Under such situation, the first processor 22 sequentially generates symbols associated with pixels included in the second image segment and the third image segment. The first processor 22 may choose not to use the pixels associated with the pixels included in the second image segment. When all of the symbols associated with the pixels included in the third image segment are completely generated (at a time point t6), the first processor 22 suspends the entropy decoding, and starts reconstructing the third image segment according to the symbols it just generated.

Similarly, starting from an ending bit (i.e., a position at which the second processor 24 previously suspended the entropy decoding) of the second image segment, the second processing 24 may continue performing the entropy decoding on the bitstream after the pixel reconstruction on the second image segment is completed (at a time point t5). When all of the symbols associated with the pixels included in the fourth image segment are generated (at a time point t7), the second processor 24 suspends the entropy decoding, and starts reconstructing the fourth image segment according to the symbols it just generated.

In the examples in FIG. 5(A) and FIG. 5(B), the first processor 22 and the second processor 24, independently perform the entropy decoding on the bitstream without exchanging information associated with the entropy decoding.

It should be noted that, the first processor 22 is not limited to start performing the pixel reconstruction on the first image segment only after the entropy decoding on the first image segment is completed. If a part of symbols associated with the pixels included in the first image segment generated by the entropy decoding is sufficient for the first processor 22 to start a part of the pixel reconstruction (e.g., sufficient for a particular image block for pixel reconstruction), the first processor 22 may start performing the pixel reconstruction. Later, the first processor 22 may continue performing the entropy decoding starting from a position at which the entropy decoding is previously suspended. As such, the first processor 22 and the second processor 24 sequentially complete the entropy decoding and the pixel reconstruction for the image blocks of the image frame according to the above scheduling.

Distinct from a conventional solution where the pixel reconstruction is performed only after the entropy decoding of an entire image frame is completed, in the present invention, the first processor 22 and the second processor 24 operate in parallel in the entropy decoding phase. By more thoroughly exercising operation resources of the second processor 24, the image processing apparatus 200 is capable of accelerating the speed for reconstructing an entire image frame.

FIG. 5(C) shows a timing diagram of a scheduling example that the image processing apparatus 200 may adopt. In this example, the first processor 22 starts performing the entropy decoding on the bitstream inputted into the image processing apparatus 200 earlier than the second processor 24. More specifically, the first processor 22 starts performing the entropy decoding from headend of the bitstream at the time point t1, suspends the entropy decoding after obtaining a first predetermined bit in the bitstream, and provides a first entropy decoding status and position information of the first predetermined bit in the bitstream to the second processor 24. In the example in FIG. 5(C), the first predetermined bit corresponds to a starting bit of the second image segment. According to the entropy decoding status and the position information the first processor 22 provides, the second processor 24 performs the entropy decoding on the bitstream from the first predetermined bit. In practice, the first processor 22 stores the entropy decoding status and the position information in the shared storage region 28 for the use of the second processor 24. That is to say, without performing the entropy decoding from the beginning of the bitstream, the second processor 24 may obtain information associated with the starting bit of the second image segment.

As shown in FIG. 5(C), starting from the time point t2, the second processor 24 performs the entropy decoding to generate the symbols associated with the pixels included in the second image segment. Similarly, the second processor 24 suspends the entropy decoding after obtaining a second predetermined bit in the bitstream, and provide a second entropy decoding status and position information of the second predetermined bit in the bitstream to the first processor 22. In the example in FIG. 5(C), the second predetermined bit corresponds to a starting bit of the third image segment. That is to say, after having decoded all of the symbols associated with the pixels included in the second image segment, the second processor 24 suspends the entropy decoding (at the time point t3), and starts reconstructing the second image segment.

After completing the pixel reconstruction on the first image segment at the time point t4, the first processor 22 may perform the entropy decoding on the bitstream (at the time point t4) from the starting bit of the third image segment according to the latest entropy decoding status and the position information the second processor 22 provided earlier. Similarly, starting from a starting bit of the fourth image segment, the second processor 24 performs the entropy decoding on the bitstream (at the time point t5) according to the latest entropy decoding status and the position information the first processor 22 provided earlier.

From FIG. 5(C) and FIG. 5(B), it is seen that by sharing the operation results of the first processor 22, the second processor 24 is not required to perform the entropy decoding from the starting bit of the first image segment. Similarly, by sharing the operation results of the second processor 24, the first processor 22 is not required to start performing the entropy decoding from the starting bit of the second image segment. Thus, operation time is reduced, such that the entropy decoding performed on the third image segment may be brought forward in time compared to the conventional process.

It should be noted that, it is not necessary that the image segments be divided in a unit of image blocks located at one row as in the above examples. In practice, based on computation speeds of the first processor 22 and the second processor 24, dependency among image blocks, and respective periods of time needed for the entropy decoding and the pixel reconstruction, one may appropriately arrange and decide in advance borders of the image segments. As such, waiting time among the first processor 22 and the second processor 24 for required data can be minimized, hence enhancing the overall performance of the image processing apparatus 200.

The concept of the present invention is applicable to a situation of more than two processors. Assuming there are three processors that can be utilized, image blocks located at the 1^{st}, 4^{th}, 7^{th} . . . horizontal rows may be reconstructed by the first processor, image blocks located at the 2^{nd}, 5^{th}, 8^{th} . . . horizontal rows may be reconstructed by the second processor, and image blocks located at the 3^{rd}, 8^{th}, 9^{th} . . . horizontal rows may be reconstructed by the third processor, and so forth.

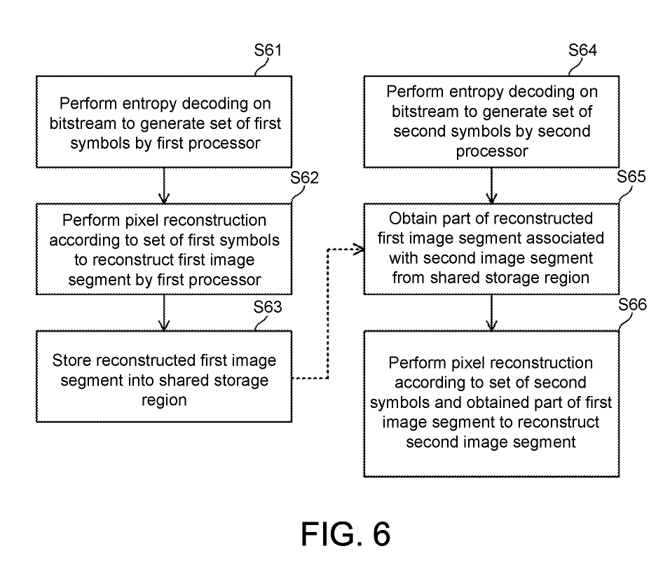

An image processing method is provided according to another embodiment of the present invention. The method reconstructs an image frame including a first image segment and a second image segment by using a first processor, a second processor and a shared storage region. FIG. 6 shows a flowchart of the image processing method. The first image segment and the second image segment are converted to a bitstream through a pixel deconstruction process and entropy decoding. In the bitstream, multiple bit associated with the second image segment are subsequent to multiple bits associated with the first image segment.

In step S61, entropy decoding is performed on the bitstream by the first processor to generate a set of first symbols. In step S62, pixel reconstruction is performed according to the set of first symbols to reconstruct the first image segment by the first processor. In step S63, the reconstructed first image segment is stored into the shared storage region by the first processor.

In step S64, the entropy decoding is performed on the bitstream by the second processor to generate a set of second symbols. It should be noted that, a time point of performing step S64 may be the same as that of performing step S61, or be later than that of performing step S61. Further, step S64 may perform the entropy decoding from a headend of the entire bitstream by using the second processor, or may perform the entropy decoding from the midst of the bitstream according to latest entropy decoding status and position information the first processor provides by using the second processor.

In step S65, a part of the reconstructed first image segment that is associated with the second image segment is obtained from the shared storage region by the second processor. Since reconstructing the second image segment may need a part of the data of the first image segment, the time point of performing step S65 may be determined by the time point at which step S63 is completed. In step S66, pixel reconstruction is performed according to the set of second symbols and the obtained part of the first image segment to reconstruct the second image segment.

One person skilled in the art can understand that, the operation variations (e.g., how to allot the subsequent reconstruction of other image segments) in the description associated with the image processing apparatus 200 are applicable to the image processing method in FIG. 6, and shall be omitted herein.

A non-transient computer-readable storage medium is provided according to another embodiment of the present invention. The non-transient computer-readable storage medium is for controlling a first processor and a second processor to reconstruct an image frame including a first image segment and a second image segment. The first image segment and the second image segment are converted to a bitstream through pixel reconstruction and entropy encoding. In the bitstream, multiple bits associated with pixels included in the second image segment are subsequent to multiple bits associated with pixels included in the first image segment. The non-transient computer-readable storage medium stores a program code, which is readable and executable by a processor. A first program code is for controlling the first processor to perform entropy decoding on the bitstream to generate a set of first symbols. A second program code is for controlling the first processor to perform pixel reconstruction on the set of first symbols to reconstruct the first image segment, and to store the reconstructed first image segment into the shared storage region. A third program code is for controlling the second processor to perform the entropy decoding on the bitstream to generate a set of second symbols. A fourth program code is for controlling the second processor to obtain the part of the reconstructed first image segment that is associated with the second image segment from the shared storage region, and to perform the pixel reconstruction according to the set of second symbols and the obtained part of the first image segment to reconstruct the second image segment.

In practice, the above computer-readable medium may be any type of non-transient medium storing an instruction that can be read, decoded and executed by a processor. A non-transient medium includes an electronic, magnetic and optical storage medium. The non-transient computer-readable medium includes, e.g., a read-only memory (ROM), a random access memory (RAM) and other types of electronic storage device, a CD-ROM, a DVD and other types of optical storage devices, and a magnetic tape, a floppy disk, a hard drive and other types of magnetic storage devices. The processor instructions may realize the present invention by using various kinds of program languages. Further, the operation variations in the description associated with the image processing apparatus 200 are application to the above computer-readable storage medium, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, for reconstructing an image frame which comprises a first image segment and a second image segment, the first image segment and the second image segment being converted to a bitstream through pixel deconstruction and entropy encoding; a plurality of bits associated with the second image segment being subsequent to a plurality of bits associated with the first image segment in the bitstream; the image processing apparatus comprising:
a shared storage region;
a first processor, performing entropy decoding on the bitstream to generate a set of first symbols, performing pixel reconstruction according to the set of first symbols to reconstruct the first image segment, and storing the reconstructed first image segment into the shared storage region; and
a second processor, performing the entropy decoding on the bitstream to generate a set of second symbols, obtaining a part of the reconstructed first image segment that is associated with the second image segment from the shared storage region, and performing the pixel reconstruction according to the set of second symbols and the part of the reconstructed first image segment to reconstruct the second image segment.

2. The image processing apparatus according to claim 1, wherein the first processor and the second processor independently perform the entropy decoding on the bitstream from a starting bit corresponding to the first image segment in the bitstream.

3. The image processing apparatus according to claim 2, wherein the first processor:
after obtaining an ending bit corresponding to the first image segment in the bitstream, suspends the entropy decoding, and starts performing the pixel reconstruction to reconstruct the first image segment; and
after completing the pixel reconstruction on the first image segment, continues performing the entropy decoding on the bitstream starting from the ending bit corresponding to the first image segment.

4. The image processing apparatus according to claim 1, wherein the first processor performs the entropy decoding on the bitstream earlier than the second processor does; the first processor suspends the entropy decoding after obtaining a first predetermined bit in the bitstream, and provides to the second processor a first entropy decoding status and position information of the first predetermined bit in the bitstream; the second processor performs the entropy decoding from the first predetermined bit on the bitstream according to the first entropy decoding status and the position information of the first predetermined bit.

5. The image processing apparatus according to claim 4, wherein the first predetermined bit is a starting bit corresponding to the second image segment in the bitstream.

6. The image processing apparatus according to claim 4, wherein the second processor suspends the entropy decoding after obtaining a second predetermined bit in the bitstream, and provides to the first processor a second entropy decoding status and position information of the second predetermined bit in the bitstream; the first processor performs the entropy decoding from the second predetermined bit on the bitstream according to the second entropy decoding status and the position information of the second predetermined bit.

7. An image processing method, reconstructing an image frame by using a first processor, a second processor and a shared storage region, a first image segment and a second image segment in the image frame being converted to a bitstream through pixel deconstruction and entropy encoding; a plurality of bits associated with the second image segment being subsequent to a plurality of bits associated with the first image segment in the bitstream; the image processing method comprising:
a) performing entropy decoding on the bitstream by the first processor to generate a set of first symbols;
b) performing pixel reconstruction according to the set of first symbols to reconstruct the first image segment, and storing the reconstructed first image segment to the shared storage region by the first processor;
c) performing the entropy decoding on the bitstream by the second processor to generate a set of second symbols; and
d) obtaining a part of the reconstructed first image segment that is associated with the second image segment from the shared storage region, and performing the pixel reconstruction according to the set of second symbols and the obtained part of the reconstructed first image segment to reconstruct the second image segment by the second processor.

8. The image processing method according to claim 7, wherein in step (a) and step (c), the first processor and the second processor independently perform the entropy decoding on the bitstream from a starting bit corresponding to the first image segment.

9. The image processing method according to claim 8, further comprising:
suspending the entropy decoding after obtaining an ending bit in the bitstream corresponding to the first image segment, and starting performing the pixel reconstruction to reconstruct the first image segment by the first processor; and
continuing performing the entropy decoding on the bitstream starting from the ending bit corresponding to the first image segment after completing the pixel reconstruction on the first image segment by the first processor.

10. The image processing method according to claim 7, wherein step (a) is performed earlier than step (c), the image processing method further comprising:
before performing step (c), the first processor suspends the entropy decoding after obtaining a first predetermined bit in the bitstream, and provides to the second processor a first entropy decoding status and position information of the first predetermined bit in the bitstream;
wherein, step (c) comprises, performing the entropy decoding from the first predetermined bit on the bitstream according to the first entropy decoding status and the position information of the first predetermined bit.

11. The image processing method according to claim 10, wherein the first predetermined bit is a starting bit corresponding to the second image segment in the bitstream.

12. The image processing method according to claim 10, further comprising:
suspending the entropy decoding after obtaining a second predetermined bit in the bitstream, and providing to the first processor a second entropy decoding status and position information of the second predetermined bit in the bitstream by the second processor; and
performing the entropy decoding from the second predetermined bit on the bitstream according to the second entropy decoding status and the position information of the second predetermined bit by the first processor.
